(19) United States
(12) Patent Application Publication
(10) Pub. No.: US 2023/0077044 A1
(43) Pub. Date: Mar. 9, 2023

(54) JET-MILLING APPARATUS AND METHOD FOR JET-MILLING

(71) Applicant: Areka Patents Inc., Dover (DE)

(72) Inventor: Carlo Canal, Monselice (IT)

(21) Appl. No.: 17/470,016

(22) Filed: Sep. 9, 2021

(51) Int. Cl. B02C 19/18; B02C 19/06; F26B 17/10

(52) U.S. Cl. CPC B02C 19/186; B02C 19/068; F26B 17/106

(57) ABSTRACT

A jet milling apparatus comprises a milling chamber having one inlet for a product to be milled and outlets for a milled end product having physical properties with respective values falling inside respective ranges, nozzles for issuing respective jets of a milling fluid having predetermined operative parameters into said milling chamber for intercepting the product to be milled and forming a fluidized material inside for drying, selecting, milling, sterilizing, clustering the product, electromagnetic field emitters designed to generate an electromagnetic field with predetermined frequencies and to orient it inside said milling chamber, monitoring devices placed at the outlets for controlling in real time the physical properties of the milled end product before exit and designed to drive the nozzles and the electromagnetic field emitters to vary and adjust the operative parameters of the jets of the milling fluid and the frequency of the electromagnetic field.

### TECHNICAL FIELD

The present invention is generally applicable to the technical field of apparatuses for crushing, pulverising, or disintegrating in general and relates a jet-milling apparatus for pulverising, dehydrating and sterilising both liquid and solid materials. The invention also relates to a jet-milling method for pulverising, dehydrating and sterilising both liquid and solid materials.

### STATE OF THE ART

As known, jet mills apparatuses are designed to mill solid and/or liquid product by means of a high-speed carrier flow, typically but not exclusively compressed air, supplied inside a milling or grinding chamber through on ore more nozzles suitably inclined on the outer wall so that the coarser material to be ground is reduced in size as it swirls.

In many processes, a product that is to be milled is held in a wet suspension in a preliminary process (precipitation, flotation, washing). If the milled end product exists in dry form, the desired final moisture content is to be selected in a complex process, such as through mechanical pre-dewatering, for instance in filter presses, and then thermal drying.

Milling to a required final degree of fineness, finally, is performed frequently in jet mills.

Typical applications are, for example, the production of talcum, silicic acid, magnesium hydroxide or ceramic ink-jet pigments.

A possible configuration is disclosed in WO2013018039, wherein an apparatus for pulverising, dehydrating and sterilising both liquid and solid materials is described having a treatment vessel for containing liquid and/or solid materials during use, in which an outlet is defined to allow discharge of the materials treated in the treatment vessel and wherein means are provided for introducing liquid and/or solid materials into the treatment vessel and there are flow generation means for generating at least one flow of fluid in the treatment vessel, said flow of fluid generating a pressure in the vessel and forming a vortex in which the fluid moves in, during use, entraining and dragging the materials introduced into the treatment vessel until they implode, thus causing, at the same time, pulverization, dehydration and sterilization.

Generally, jet milling apparatuses are devices characterized by a simple configuration of the grinding chamber, with top and bottom surfaces easy to separate and reassemble, and designed for allowing easy cleaning operations, both before and after operation.

On the other hand, the known jet milling apparatuses relies solely upon the air flow to grind the material in the grinding chamber, so it is difficult to grind the material to a specified particle size or control the particle size distribution to a narrow enough range.

An additional drawback of the existing solutions relies on the fact that these solutions do not allow selective grinding.

Various improvements have been attempted with a view to grinding the material to a specified particle size or narrowing the particle size distribution.

Some known solutions, one of which is disclosed, for example, in JP 52-44450 A, provide air nozzles that permit adjustment of the angle at which the air flow is injected into the grinding chamber to enable control of the ground particle size distribution over a wide range.

However, although enabling control of the ground particle size distribution over a wide range, the swirling fluid-energy mill disclosed in this document suffers from a problem of a poor classification precision, since the mill injects compressed air to grind a material and at the same time forms swirling flow to perform classification, thereby also ejecting yet large particles.

JP 63-319067 A discloses a special classification mechanism, such as a classification rotor provided around an exit pipe to improve classification precision and impact elements.

However, the horizontal swirling flow jet mill, while resolving the problem of a poor classification precision of the mill, suffers for the presence of turbulence generated in swirl and for the fact that the fine particles adhere to the rotor wall, due to a difference in speed between the swirling flow formed by the compressed air and that formed by the classification rotor.

JP 57-84756 A discloses, in turn, a grinding chamber provided at its inside with spherical, cylindrical or hemispherical shape provided inside the grinding chamber against which the material to be ground is forced to collide to achieve the higher grinding efficiency in the grinding chamber.

However, the presence of the impact elements obstructs the air flow, generating a significant turbulence in the swirling flow to thereby lower the classification precision or to allow the ground material to heavily adhere to the impact elements, resulting in difficulty with a stable and continuous operation.

Moreover, all these prior arts require that additional shaped mechanical parts be complexly provided inside the grinding chamber, as exemplified by the special mechanism for adjusting the angle at which the air flow is injected, the special mechanism for classification, and the special impact elements provided inside the grinding chamber.

These additional complex mechanical components reduce the advantageous features of the jet milling apparatuses, i.e. the simple configuration of the interior of the grinding chamber, the possibility of an easy separation and reassembling of the top and bottom surfaces of the grinding chamber, the ease of cleaning, both before and after operation.

Therefore, the aforementioned prior arts have not been completely satisfactory.

A further drawback of the known milling apparatuses relies on the fat that they are not suitable to pre-select and treat only the desired selected components in the mixture of grind and it is requested a pre-selection with complex processes and machineries.

The disadvantage of existing jet-mill apparatus is the need for high total expenditure in equipment and time to obtain a millable product from a wet suspension, eventually with a desired final moisture content and final degree of fineness or for a selected material into the mixture.

### SCOPE OF THE INVENTION

The object of the present invention is to overcome the above drawbacks, by providing a jet milling apparatus, characterized by high efficiency joined to a simple configuration of the milling chamber.

A particular object is to provide a jet milling apparatus suitable to carry out milling, drying, sterilizing and clustering of the selected products in a common process step, to have a process conducted substantially in a more simple and reasonable manner in terms of time and energy consumption.

A particular object is to provide a jet milling apparatus allowing to carry out a grinding or milling process that provides the desired or selected particle size with a narrower size distribution of a higher classification precision and which still retains the three advantageous features of the jet mill, i.e. simple configuration of the milling chamber, top and bottom surfaces of the milling chamber easy to be separated and reassembled, ease cleaning of the chamber, both before and after operation.

These objects, as well as others which will become more apparent hereinafter, are achieved by a jet milling apparatus that, according to claim 1, comprises a milling chamber having at least one inlet for a product to be milled and one or more outlets for a milled end product having physical properties with respective values falling inside respective ranges, one or more nozzles for issuing respective jets of a milling fluid having predetermined operative parameters into said milling chamber for intercepting the product to be milled and forming a fluidized material inside said milling chamber for drying, selecting, milling, sterilizing, clustering the product, one or more electromagnetic field emitters placed at said milling chamber and designed to generate an electromagnetic field with predetermined frequencies and to orient it inside said milling chamber, monitoring devices placed at each of said one or more outlets for controlling in real time the physical properties of the milled end product before exit from said milling chamber, wherein said monitoring devices are designed to drive at least said one or more nozzles and said electromagnetic field emitters to vary and adjust the operative parameters of the jets of the milling fluid and the frequency of the electromagnetic field in such a way that combined action of drying, milling, clustering of the product to be milled occur.

The electromagnetic field added to the spinning material will excite the nuclear activity of the material. Being a specific frequency in reference of the materials to be treated, the system will enter in resonance amplifying and converting the power present into the vortex and giving a resonance feedback to the monitoring device. In the process, by appropriate selection of at least one operating parameter (particle sizes, pressure, tension-reducing pressure, vibrations, resonance frequencies, flow, and/or other variables as temperature, color, density), the specific operating condition required for milling are selected.

Finally, the end product is released from the jet mill with the predetermined final values.

Another advantageous option is to measure or monitor the content of the grist before it is released from the jet mill as end product.

According to a preferred refinement thereof, it is also possible that at least one operational parameter of the jet mill is appropriately adjusted, controlled or regulated once or repeatedly at time intervals or at least approximately continuous for the combined drying and milling, depending on one hand on the actual final values of the grist before it is released from the jet mill or of the actual final values of the end product, and on the other hand on the predetermined final values of the end product.

Final moisture content, temperature, size, and possibly other parameters, monitoring devices are preferably linked to the end product outlets of the jet mill to monitor the actual final values of the product before its release from the milling chamber or the actual final values of the end product, which is obtained by milling and drying in the jet milling chamber.

Preferably, the adjusting, controlling or regulating devices are configured in such a way that, by appropriate selection of the operating parameters, the specific operating setting required for milling is selected in such a way that it is greater than or equal to the specific operating means required for drying.

An additional preferred configuration consists in the use of gases, liquids or superheated steams as carrier.

According to a further aspect of the invention a jet milling method according to claim 12 is provided, which method comprising the following steps:
a) introducing a predetermined amount of a product to be milled inside a milling chamber;
b) supplying one or more jets of a milling fluid having predetermined operative parameters inside said milling chamber for intercepting the product to be milled and forming a fluidized material inside said milling chamber for drying, selecting, milling, sterilizing, clustering the product;
c) generating an electromagnetic field with predetermined frequencies and orienting it inside said milling chamber;
d) controlling in real time the physical properties of the milled end product before exit from said milling chamber;
e) varying and adjusting the operative parameters of the jets of the milling fluid and the frequency of the electromagnetic field in such a way that combined action of drying, milling, clustering of the end product to be milled occur with said end product having physical properties having values falling inside predetermined ranges.

Advantageous embodiments of the invention are obtained in accordance with the dependent claims.

### BREIF DISCLOSURE OF THE DRAWINGS

Further features and advantages of the object of the invention will become more apparent in the light of the detailed description of a preferred but not exclusive embodiment of the jet milling apparatus according to the invention, shown by way of non-limiting example with the aid of the attached drawing tables wherein:

FIG. 1 shows in a schematic sectional view an embodiment of a jet milling apparatus having a cone-shaped milling chamber with multiple outlets.

FIG. 2 shows in a schematic sectional view of the jet milling of FIG. 1 during operation.

### BEST MODE OF CARRYING OUT THE INVENTION

With reference to the attached figures, a preferred but not exclusive configuration of a jet milling apparatus according to the invention is disclosed.

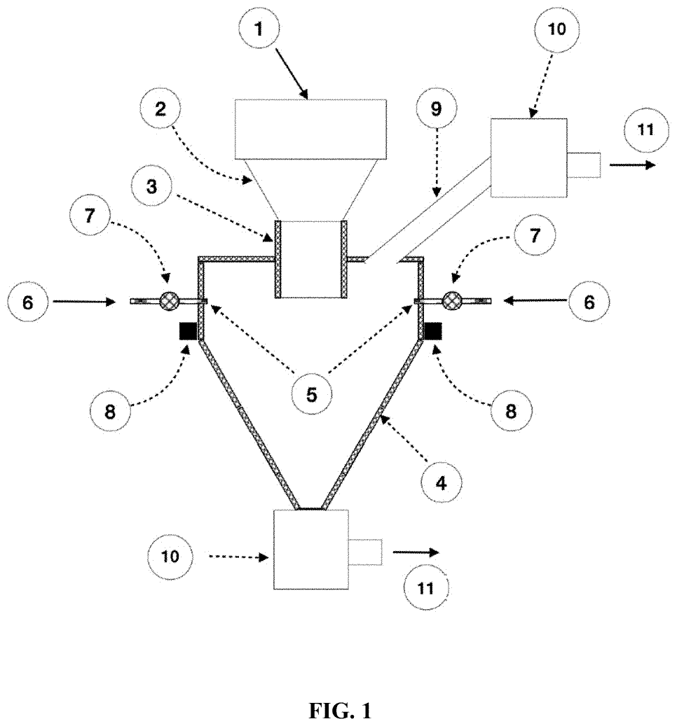

As visible in FIG. 1, the apparatus comprises a cone-shaped milling chamber 4 provided with automated dosing chamber 2 having an inlet 1 for the product to be milled, motorized inlet feeder 3, milling zone 14, mill carrier 6, motorized nozzles 7 having respective discharge port 5 inside the milling chamber 4 for emitting respective jet of a fluid thereinside, electromagnetic field emitters 8, monitoring devices 10 with respective separator chamber with feedback sensors, exit conduit 9 and end product outlets 11.

However, it is understood that the present configuration has to be considered only in way of example, as the chamber could have a different shaping as also have a different number of inlets and/or outlets.

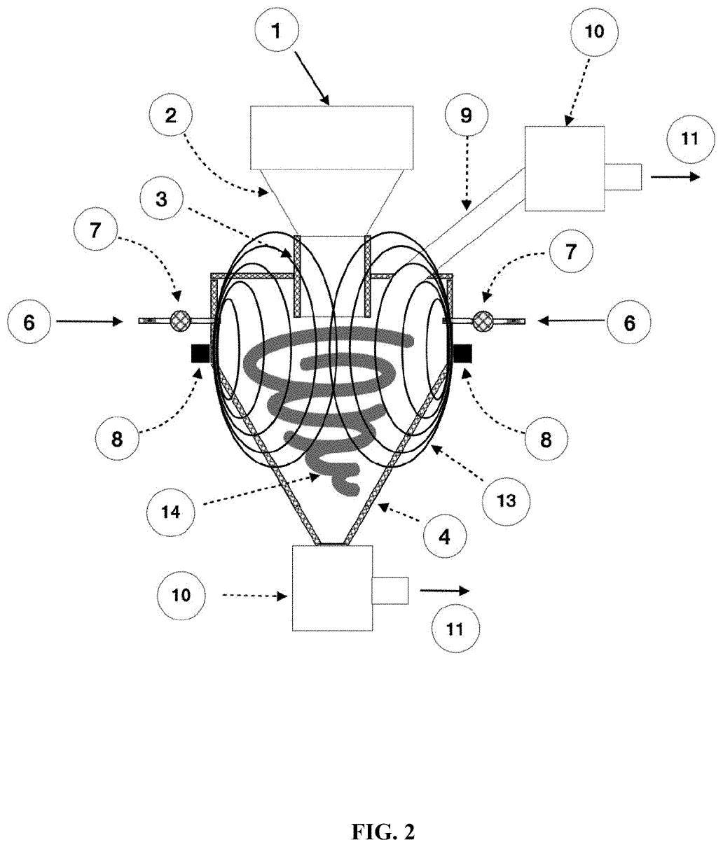

FIG. 2 shows in a schematic sectional view the operating means, depending on the achieved milled fineness for an operating means pressure of 4 bar (abs) to 14 bar (abs) depending on application or material processed; it also shows the spin of operating means covered by electromagnetic field. The spinning direction will be reversed in south hemisphere.

The product or grist is conveyed to the jet milling chamber 4 via the motorized inlet feeder 3, through the automated dosing chamber 1 placed at the inlet 1 of the milling chamber 4.

Motorized carrier 6 for the nozzles 7 are preferably at least in number of three and oriented clockwise or opposite direction, depending on final installation area (north or south hemisphere) with defined degrees.

In the internal milling zone 14 of the milling chamber, by means of the jets issuing out of the nozzles 7, preferably air or gases or mixed gases or liquids or superheated steams, a fluidized material is formed from which the grist enters the vortex, where the particles contained therein are accelerated to high speeds.

The accelerated particles encounter one another in the vortex as well as in the center of the milling zone 14 and thereby are fragmented.

Depending on application, the variable parameters change to obtain a critical phase inside the milling chamber, where the electrons, activated by electromagnetic field 13, will reach a speed to help the breakdown of grist without impact.

The water is released without changing phase and will exit as micro drops. As happen inside the tornados, the fast changes of temperatures into the vortex created in the cone-shaped milling chamber by the speed of the carrier determine the inversion of the flow and the sterilization side effect. Level of sterilization is fully dependent of other variables, not mentioned.

Linked to the milling chamber and to the end product outlets are monitoring devices for ascertaining or monitoring variable values of products, to ascertain or monitor in realtime the actual values before its release from the jet mill.

The particles corresponding to the adjusted conditions end up in the end product outlet separation/verification chamber of the monitoring device 10.

The monitoring devices are provided, inside their separation chambers, with feedback sensors connected to microprocessor based electronic board that drive automated dosing chamber 2 having an inlet 1 for the product, motorized inlet feeder 3, motorized nozzles 7, electromagnetic field emitters 8, and possible other special equipments or devices added for specific applications.

Adjusting, controlling or regulating devices are provided inside the monitoring device 10 to adjust, control or regulate at least one operating parameter of the jet milling apparatus.

By means of the adjusting, controlling or regulating devices, at least one operating parameter of the jet milling apparatus may be appropriately selected in such a way that combined action, as drying, milling, clustering, occur. The clustering of the material is also considered as operating parameter and best results are obtained with the optimization of the above-mentioned sensor and electronic driven controlled devices.

Preliminary pressure, tension-relieving pressure or input temperature, in particular, are foreseen as at least one operating parameter that is adjustable, controllable or regulatable by means of the adjusting, controlling or regulating devices.

The adjusting, controlling or regulating devices are preferably configured in such a way that, by appropriate choice of the above operating parameters, the specific operating means required for milling is selected.

The end product outlets of the jet milling apparatus is configured in such a way that only the selected end product with the predetermined final range of variables, i.e. degree of fineness, moisture content, sterilization and clusterization, is released from the jet mill through the end product outlets.

As known in general, milling is characterized by adiabatic energy input. Adiabatic energy designates the energy that is released in the form of kinetic energy upon adiabatic expansion of pressurized gases or steam.

It can be computed for ideal gases by the following equation:

$${E}_{ad} = \frac{k}{k - 1} \cdot m \cdot R \cdot {T}_{0} \cdot [ 1 - {( \frac{{p}_{1}}{{p}_{0}} )}^{\frac{k - 1}{k}} ]$$

wherein
k is the isentropic exponent
m is the gas mass
R is a gas constant
T₀ is the gas input temperature
p₁ is the tension-relieving pressure
p₀ is the gas pressure before tension relief

As known in general, for steams, this energy is obtained for the case of isentropic tension relief from the h-s diagram as the enthalpy difference between the input and tension relief conditions, again depending on steam preliminary pressure, steam input temperature and tension-relieving pressure (see, for example, Water and Steam, Springer Verlag, Berlin—Heidelberg, 2000).

As can be recognized from the above equation, analogously with steams, the adiabatic energy input is modified at constant operating material mass and at varying input temperature or changing pressure conditions.

The mass throughput of the product that is to be milled to a desired final degree of fineness is thereby modified as well. That is, the ratio of the grist mass and operating means mass (=specific operating means consumption in kg/kg) is variable depending on the appropriate selection of operating parameters.

The method is valid as above if a low-pressure carrier is used. As soon as we modify the operational conditions modifying the spinning under electromagnetic field, the resonance environment will start.

Resonant frequency is a physical phenomenon that occurs whenever waves or vibrations are involved. Resonance can create large, destructive oscillations, for example when the pitch of a sound matches the resonant frequency of material. An increase in the speed of vibration corresponds to a decrease in the density of the energy, and due to the change in vibrational state the solid material tends to melt or break down.

The material is composed of atoms. All material absorbs or reflect differently depending on the molecular bonds present in the specific material. Heat, which determine an increase in vibrational speed, makes the water even less solid, causing it to transform into vapor. Chemical bonds formed by long chains of highly poisonous compounds can be broken down into less harmful or completely harmless molecular groups.

Continuing the application of the pulsing frequency to the chamber after resonance occurs, the energy level within the molecule is increased in cascading incremental steps in proportion to the number of pulses; maintaining the charge of material during the application of the pulsing field, (whereby the co-valent electrical bonding of the atoms within molecules is destabilized such that the force of the electrical field applied, as the force is effective within the molecule, exceeds the bonding force of the molecules), and atoms are liberated from the molecule as elemental gases or micro powder.

Those gases and/or micro-powder that were formerly part of macro molecule of inlet material are collected in clusters before to exit from milling chamber as end product. The repetitive application of a voltage pulse train incrementally achieves the critical state of the ions. As the atoms or ions become elongated during electron removal, electromagnetic wave energy of a predetermined frequency and intensity is injected. The wave energy absorbed by the stimulated nuclei and electrons causes further destabilization of the ionic gas. The absorbed energy from all sources causes the gas nuclei to increase in energy state and induces the ejection of electrons from the nuclei.

The typical vortex streamline (a line that is everywhere tangent to the flow velocity vector) is a closed loop surrounding the axis; and each vortex line (a line that is everywhere tangent to the vorticity vector) is roughly parallel to the axis. A surface that is everywhere tangent to both flow velocity and vorticity is called a vortex tube. In general, vortex tubes are nested around the axis of rotation. The axis itself is one of the vortex lines. The vortex streamlines are held tighter by electromagnetic layers. Such streamlines have different motions relative to one other. They are slow at the edges and fast toward the center. At the center of the vortex the speed is very high and the inner forces consequently also increase proportionally. The structures of the molecules are not able to support such differences in pressure, and therefore even complex molecular bonds are separated into tiny portions, releasing enormous amount of energy.

In the present apparatus, the material is brought to an higher vibrational state, where it passes through a temporary change of phase. When the vortex is deactivated and the energy effects disappear, the matter therefore returns to its normal state.

A molecular vibration is a periodic motion of the atoms of a molecule relative to each other, such that the center of mass of the molecule remains unchanged. The typical vibrational frequencies range from less than 1013 Hz to approximately 1014 Hz, corresponding to wave numbers of approximately 300 to 3000 cm−1. Vibrations of polyatomic molecules are described in terms of normal modes, which are independent of each other, but each normal mode involves simultaneous vibrations of different parts of the molecule. In general, a non-linear molecule with N atoms has 3N—6 normal modes of vibration, but a linear molecule has 3N—5 modes, because rotation about the molecular axis cannot be observed. A diatomic molecule has one normal mode of vibration, since it can only stretch or compress the single bond. A molecular vibration is excited when the molecule absorbs energy, ΔE, corresponding to the vibration's frequency, ν, according to the relation

ΔE=hν,

where h is Planck's constant.

A fundamental vibration is evoked when one such quantum of energy is absorbed by the molecule in its ground state. When multiple quanta are absorbed, the first and possibly higher overtones are excited. To a first approximation, the motion in a normal vibration can be described as a kind of simple harmonic motion. In this approximation, the vibrational energy is a quadratic function (parabola) with respect to the atomic displacements and the first overtone has twice the frequency of the fundamental. In reality, vibrations are anharmonic and the first overtone has a frequency that is slightly lower than twice that of the fundamental. Excitation of the higher overtones involves progressively less and less additional energy and eventually leads to dissociation of the molecule, because the potential energy of the molecule is more like a Morse potential or more accurately, a Morse/Long-range potential. The vibrational states of a molecule can be probed in a variety of ways. The most direct way is through infrared spectroscopy, as vibrational transitions typically require an amount of energy that corresponds to the infrared region of the spectrum.

Raman spectroscopy, which typically uses visible light, can also be used to measure vibration frequencies directly. The two techniques are complementary and comparison between the two can provide useful structural information such as in the case of the rule of mutual exclusion for centrosymmetric molecules. Vibrational excitation can occur in conjunction with electronic excitation in the ultraviolet-visible region. The combined excitation is known as a vibronic transition, giving vibrational fine structure to electronic transitions, particularly for molecules in the gas state. Simultaneous excitation of a vibration and rotations gives rise to vibration-rotation spectra.

The use of such principles leads to a new vision within the field of material micronization, dehydration, sterilization and clustering to speed up processes and reducing the amount of energy to reach the final results.

1. A jet milling apparatus, comprising:
a milling chamber having at least one inlet for a product to be milled and one or more outlets for a milled end product having physical properties with respective values falling inside respective ranges;
one or more nozzles for issuing respective jets of a milling fluid having predetermined operative parameters into said milling chamber for intercepting the product to be milled and forming a fluidized material inside said milling chamber for drying, selecting, milling, sterilizing, clustering the product;
one or more electromagnetic field emitters placed at said milling chamber and designed to generate an electromagnetic field with predetermined frequencies and to orient it inside said milling chamber;
monitoring devices placed at each of said one or more outlets for controlling in real time the physical properties of the milled end product before exit from said milling chamber;
wherein said monitoring devices are designed to drive at least said one or more nozzles and said electromagnetic field emitters to vary and adjust the operative parameters of the jets of the milling fluid and the frequency of the electromagnetic field in such a way that combined action of drying, milling, clustering of the product to be milled occur.

2. The jet milling apparatus as claimed in claim 1, wherein the operative parameters of the jets of the milling fluid to be varied and adjusted by said monitoring devices are preliminary pressure and/or tension-relieving pressure and/or input temperature.

3. The jet milling apparatus as claimed in claim 2, wherein said monitoring devices comprises electronic feedback sensors adapted to detect said parameters and a microprocessor based electronic board connected to the sensors to receive the detected parameters.

4. The jet milling apparatus as claimed in claim 3, wherein said monitoring devices comprises a separation chamber in communication with the respective of said one or more outlets for receiving the milled end product and housing said electronic feedback sensors.

5. The jet milling apparatus as claimed in claim 4, wherein said one or more outlets is configured to release only the milled end product having physical properties having values falling inside predetermined ranges.

6. The jet milling apparatus as claimed in claim 5, wherein said physical properties of the milled end product are selected into the group comprising degree of fineness, moisture content, sterilization grade and clusterization.

7. The jet milling apparatus as claimed in claim 1, wherein said milling chamber comprises an automated dosing unit placed at said at least one inlet and provide with a motorized inlet feeder for conveying the product to be milled from said dosing unit inside said milling chamber.

8. The jet milling apparatus as claimed in claim 7, wherein said milling chamber comprises a cone-shaped milling zone placed upstream said at least one inlet.

9. The jet milling apparatus as claimed in claim 8, wherein said milling zone is cone-shaped.

10. The jet milling apparatus as claimed in claim 8, wherein said one or more nozzles are motorized and are at least in number of three with respective discharge openings for the corresponding jets placed inside said milling zone.

11. The jet milling apparatus as claimed in claim 1, wherein the milling fluid is air or a gas or mixed gases or a liquid or mixed liquids or superheated steam.

12. A method for jet milling a product, comprising the following step:
a) introducing a predetermined amount of a product to be milled inside a milling chamber;
b) supplying one or more jets of a milling fluid having predetermined operative parameters inside said milling chamber for intercepting the product to be milled and forming a fluidized material inside said milling chamber for drying, selecting, milling, sterilizing, clustering the product;
c) generating an electromagnetic field with predetermined frequencies and orienting it inside said milling chamber;
d) controlling in real time the physical properties of the milled end product before exit from said milling chamber;
e) varying and adjusting the operative parameters of the jets of the milling fluid and the frequency of the electromagnetic field in such a way that combined action of drying, milling, clustering of the end product to be milled occur with said end product having physical properties having values falling inside predetermined ranges.

13. The method as claimed in claim 12, wherein said physical properties of the milled end product are selected into the group comprising degree of fineness, moisture content, sterilization grade and clusterization.

14. The method as claimed in claim 13, wherein the operative parameters of the jets of the milling fluid to be varied and adjusted are preliminary pressure and/or tension-relieving pressure and/or input temperature.

15. The method as claimed in claim 12, wherein drying, selecting, milling, sterilizing, and clustering of the product are carried out in a single step.
